(19) United States
(12) Patent Application Publication
(10) Pub. No.: US 2006/0078797 A1
(43) Pub. Date: Apr. 13, 2006

(54) Lithium ion battery and methods of manufacture

(75) Inventor: M. Zafar A. Munshi, Missouri City, TX (US)

Correspondence Address: DONALD R. GREENE, P.O. BOX 6238, GOODYEAR, AZ, 85338, US

(73) Assignee: Lithium Power Technologies, Inc., Manvel, TX (US)

(21) Appl. No.: 11/285,046

(22) Filed: Nov. 21, 2005

Related U.S. Application Data
(63) Continuation of application No. 10/703,178, filed on Nov. 5, 2003, now abandoned.
(60) Provisional application No. 60/424,932, filed on Nov. 9, 2002.

(51) Int. Cl. H01M 4/58; H01M 4/66

(52) U.S. Cl. 429/231.8; 429/231.4; 429/128; 429/245; 29/623.1

(57) ABSTRACT

A lithium ion battery includes an anode, a cathode, and an electrolyte between the two. When the battery is in its initial charged state, as it is upon exiting the manufacturing process, the anode is composed of a first portion of lithium-deficient electrode material, and a second portion of lithium-rich or lithium-intercalated material coated on at least a part of the surface of the first portion. And the cathode is composed of lithium-deficient material adapted to react reversibly with lithium ions from the lithium-rich second portion of the anode during subsequent discharge of the battery from its initial charged state as the second portion becomes fully consumed. During each subsequent charge-discharge reaction cycle, free lithium ions from the cathode are inserted into the lattice structure of the solely remaining first portion of the anode to render it lithium-rich in the charged state, without plating lithium metal onto the anode, and lithium ions from the anode are re-inserted into the lattice structure of the cathode to render it lithium-rich in the discharged state. Methods of manufacture are described.

### CROSS-REFERENCE TO RELATED APPLICATIONS

This application claims the benefits of priority of provisional application No. 60/424,932, filed Nov. 9, 2002, which is incorporated herein, of the same inventor and assignee.

### BACKGROUND OF THE INVENTION

A. Field

The present invention relates generally to new designs and methods of manufacture of lithium ion batteries characterised by high energy density, improved stability, wide range of voltages specifically lower voltage, lower self-discharge, greater safety, lower cost, and to methods of manufacturing such batteries.

B. Prior Art

A high energy density rechargeable battery system is currently a highly sought technology objective. This is attributable in large part to the proliferation of power-consuming portable electronics that demand increasingly greater energy levels, and to greater interest in practical electric-powered vehicles with significantly improved range presently unavailable from lead acid batteries. In particular, lithium rechargeable batteries are the focus of intense investigation around the world, including a large number of lithium batteries with different chemistries.

Table I, below, lists characteristics of five lithium systems, for example, among those currently either in commercial production or under development, with comparison to characteristics of conventional lead-acid batteries. Lead-acid batteries with a specific energy of only 40 Wh/kg yield a driving range in an electric vehicle of only about 50 miles at moderate speed. While this type of battery is relatively inexpensive, it suffers disadvantages of low energy, heavy weight, and toxicity. An acceptable driving range of 300 miles is calculated to be achievable from a battery with a specific energy of at least 240 Wh/kg. Lithium metal anode batteries offer possibilities of meeting this objective. However, presently available commercial rechargeable lithium ion batteries are unable to attain the viable target range—and rechargeable lithium batteries currently under investigation, such as the lithium polymer electrolyte battery, suffer from operating problems at the lower temperature range, such as below room temperature.

The exemplary lithium systems are discussed below, with numbering as listed in Table I.

TABLE 1
Performance Characteristics of Lithium Rechargeable Batteries

| | | | Energy Density | | Voltage | | Range in | Cycle |
|---|---|---|---|---|---|---|---|---|
| | System | Type | Wh/kg | Wh/liter | (v) | Electrolyte | EV/miles | Life |
| 1 | Lead-Acid | Rechargeable | 40 | 65 | 2 | Sulfuric Acid | 50 | 500 |
| 2 | Li—MnO2 | Primary | 250 | 450 | 3 | Liquid (Organic) | N/A | None |
| 3 | Li-Metal | Rechargeable | 200-250 | 300-350 | 2-3.5 | Liquid (Organic) | Not viable | 150 |
| 4 | Li-Polymer Electrolyte | Rechargeable | 250-350 | 350-500 | 2-3.5 | Solid (Organic) | 300-350 | >1000 |
| 5 | Lithium Ion | Rechargeable | 130-180 | 260-300 | 3.6-3.7 | Liquid (Organic) | 200 | 500-800 |
| 6 | Lithium Ion Polymer | Rechargeable | 130-180 | 260-300 | 3.6-3.7 | Gel (Organic) | 200 | 500-800 |

Note:
In Table 1, Wh/kg is specific energy (gravimetric); Wh/liter is energy density (volumetric). Where Li is denoted, it refers to a lithium metal anode battery, and where the word “Lithium” it denoted as in Lithium Ion, it refers to a carbon anode or insertion anode battery.

Primary Lithium Liquid Electrolyte Battery

Among the advantages of a lithium anode battery are its high energy density, high voltage, and low self-discharge. System 2 in Table I is a lithium metal anode battery that incorporates liquid solvent(s) as the electrolyte absorbed in a microporous polyethylene or propylene separator, and a non-rechargeable cathode. The cathode may comprise an insertion cathode, i.e., lithium ions inserted into the cathode lattice, or may react with the lithium ions irreversibly during cell discharge as described below. This system is a primary battery, and typically, the anode capacity is balanced to the cathode capacity. It has been commercially available since the 1970s for specialty uses such as still cameras and electronic circuit boards, to name a few, and is not a viable candidate for an electric vehicle because it is non-rechargeable. 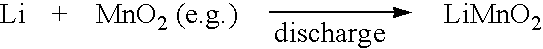
Rechargeable Lithium Liquid Electrolyte Battery

System 3 is a lithium metal anode battery that also incorporates a liquid organic solvent electrolyte, but includes a rechargeable cathode. The active cathode may be selected from a wide range of oxides, sulfides and selenides, or any other group well known in the prior art, e.g., LiMn₂O₄, LiₓMnO₂, LiₓCoO₂, LiₓV₂O₅, LiₓV₆O₁₃, LiₓV₅S₈, LiₓTiS₂, LiₓV₃O₈, LiₓV₂S₅, LiₓNbSe₃, LiₓNiO₂, LiₓNi_{y}CO_{z}O₂, LiₓNi_{y}Mn_{z}O₂, LiₓCo_{y}Mn_{z}O₂, lithium doped electronically conducting polymers such as polypyrrole, polyaniline, polyacetylene, polyorganodisulfides, and so forth. Typically lithium anode cells are fabricated in the charged state, and the cell discharge is similar to that of the primary lithium battery, except that the product(s) of the reaction are reversible, i.e., the lithium from the cathode is re-plated as lithium metal on the anode electrode during charge. The cell voltage of a lithium metal battery is typically less than 4 volts. It is believed that the low self-discharge of this battery is attributable to its lower cell voltage.

Despite their success as an anode in primary batteries, rechargeable lithium metal anode batteries in contact with liquid organic electrolytes are known to have many problems—most notably, poor safety. Lithium is a very reactive element with most inorganic and organic electrolytes. The relatively poor cycling efficiency of the lithium anode arises because it is not thermodynamically stable in typical nonaqueous electrolytes. Each time fresh lithium is re-plated on the anode during charge, a finite amount of lithium is consumed irreversibly by the electrolyte. Consequently, cells contain at least three-to-five fold excess lithium to ensure a reasonable cycle life. Despite the very high capacity of lithium of 3.86 Ah/g, the excess lithium in the battery has an effect of lowering the energy density of the battery. Furthermore, the lithium plating and stripping during the charge and discharge cycles creates a porous deposit of high surface area and increased activity of the lithium metal with respect to the electrolyte. The reaction is highly exothermic and the cell can vent with flame if heated.

Considerable effort has been expended to improve the cycling efficiency of the lithium anode through such approaches as change of the electrolyte, or application of a stack pressure, or use of lithium alloys that are less reactive than metallic lithium. However, none of these approaches has led to a commercial lithium anode battery with expected attributes such as high volumetric and gravimetric energy and power densities, high cycle life, low cost, and, most importantly, safety. Thus, many battery companies have abandoned this technology for commercial use.

Rechargeable Lithium Polymer Electrolyte Battery

System 4 is a lithium solid-state polymer electrolyte battery that offers improved safety, energy density, and cycle life, thus alleviating many of the problems associated with a lithium metal anode battery in contact with a liquid organic solvent. The polymer electrolyte is an ionically conductive material that replaces the liquid organic solvent and the microporous separator. The chemical and electrochemical attributes of the lithium anode are more stable in contact with a polymer electrolyte than with liquid solvents. As a result, the cycling efficiency is significantly improved in such electrolytes, without a requirement of three-to-five fold excess lithium. This allows the use of properly balanced anode and cathode capacities in such cells, which results in higher energy densities and cycle life than rechargeable lithium batteries incorporating liquid electrolytes. Unfortunately, the electrolyte conductivity is not high enough for ions to move rapidly through the electrolyte at room temperature and in its present stage of development, this otherwise desirable system is not viable at temperatures below 60° C.

Rechargeable Lithium Ion Liquid Electrolyte Battery

To overcome the issues of lithium metal instability in rechargeable cells incorporating liquid organic solvent electrolytes, Sony Energytec introduced a new concept in rechargeable lithium batteries—referred to as a lithium ion battery (system 5),—which uses a carbon anode instead of lithium metal, and a lithiated cobalt oxide as the cathode. Unlike lithium anode batteries, such cells are fabricated in the discharged state as all the lithium is initially in a compounded form in the cathode. This is the general premise for a lithium ion battery where the cathode comprises reversible lithium ions in its lattice. The cell is activated by first charging the battery, which allows lithium to exit or deintercalate the cathode and to enter the lattice of the carbon anode. Once this reaction is complete, the battery is fully charged. The charge and discharge reactions, i.e. the intercalation and de-intercalation of lithium ions in the carbon and lithiated cobalt oxide structures, are highly reversible. Since no lithium plating is involved in the reactions as in a lithium metal anode battery, and no lithium metal reaction with the electrolyte, such batteries are relatively safe.

No generic lithium ion chemistry exists since each manufacturer has its own chemistry containing different positives, different negatives, binders, electrolytes, electrolyte additives and formation processes. These are major factors influencing cycle life and the charge and discharge profiles. The most common lithium sink (i.e., place where the ion inserts) negative electrodes in a lithium ion battery are carbon-type insertion compounds, while layered metal oxides of the LiMO₂ type (where M=Ni or Co) or spinel lithium manganese oxides of the LiMn₂O₄ type are currently used as preferred lithium source positive electrodes. The capacities of these nickel, cobalt, or manganese oxides are in the range of 120-140 mAh/g. When combined with a carbon electrode with a specific capacity of 320-340 mAh/g, the delivered energy density is about 160 Wh/kg. Furthermore, the cobalt, nickel and manganese oxide materials are air-stable and typically the electrodes are fabricated in the ambient atmosphere. These electrodes are usually calendared onto metallic current collectors (which are about 25 to 50 microns thick). The overall process of these batteries may be written as:

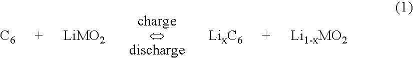

As indicated by the above cell reaction, charge and discharge proceed via intercalation of lithium ions into the carbon and metal oxide structure, respectively. Cell voltage at full charge is usually 4.2 volts while cell voltage on discharge is 2.6 volts. It is believed that the high self-discharge is a consequence of the high cell voltage and the instability of the electrodes to hold their charge.

Some lithium ion battery suppliers use coke anodes while others use graphite. Graphite-anode cells tend to have a flatter discharge profile and an average cell voltage of 3.7 V, while coke-anode cells provide a sloping discharge curve at an average voltage of 3.6 V. The energy density of the graphite-anode battery runs higher than that of the coke-based battery and its high discharge voltage results in greater usable capacity. Although improvements are being made to this system by utilizing other anodes such as tin oxide, which can provide up to 700 mAh/g capacity, such systems remain under development at the present time.

Electrolytes are usually based on solutions of LiPF₆ in high viscosity organic carbonate solutions such as EC-PC (EC=ethylene carbonate, PC=propylene carbonate) solvent mixtures. These electrolytes offer greater electrochemical stability at the high cell voltage compared to lower viscosity electrolytes. This often leads to a lower ionic conductivity than what could be achieved with a lower viscosity solvent. The high viscosity electrolyte is not only poorly conductive, but is also heavy,—leading to a lowering in the energy density and power density of the battery. In fact, each manufacturer has a different formulation for the carbonate-based electrolyte. These electrolytes are very expensive, moisture sensitive, and must handle the high voltages of the batteries. Despite this, the high voltage of the battery oxidizes the electrolyte on the conductive carbon in some cell configurations. While electrolytes based on PC and a low boiling co-solvent served well with amorphous carbons such as coke, an EC-based electrolyte is necessary for the safety and operation of cells containing crystalline carbons such as graphite. The combination of carbon with high voltage cathodes, such as LiCoO₂ (4.2 V vs. Li), LiNiO₂ (4.1 V vs. Li) and LiMn₂O₄ (4.4 V vs. Li), makes lithium ion batteries capable of operating at high voltage levels. Although most commercial cells use LiCoO₂ cathodes, compounds including LiNiO₂, LiMn₂O₄ and lithiated mixed nickel, cobalt and manganese oxides have promised advantages in energy density and/or low cost. Some new cathode materials being investigated are based on Li_{1-x-y}CoₓNi_{y}O₂ and Li_{1-x-y}CoₓNi_{y}Al_{z}O₂. These and other combinations of Ni, Co, and Mn in the lattice structure offer somewhat higher capacities of about 150 mAh/g and improved thermal stability over the stoichiometric metal oxides, leading to specific energy and energy density of about 180 Wh/kg and 300 Wh/l, respectively. However, the cost of these cathodes appears to be higher than the stoichiometric oxides.

Other groups are evaluating lithiated metal phosphates based on a wide composition range, including LiₓFePO₄ and LiₓV₂(PO₄)₃. These phosphates offer specific capacities ranging from 110 mAh/g to 160 mAh/g,—but the discharge voltage is much lower, leading to lower energy densities than the cobalt, nickel, or manganese oxides. Furthermore, the rate capabilities of these phosphate-based cells are also lower. Despite these improvements to the cathode, anode and liquid solvent electrolyte, including the packaging, the overall improvement to the gravimetric and volumetric energy densities are still incremental and not sufficient to make the electric vehicle a viable proposition from the present lithium ion battery and those under development (about 200 miles driving range).

These batteries are, however, commonly used in portable computers, cellular telephones and camcorders, among other applications. The packaged battery, usually in a hard plastic case, has a much lower energy density than the individual cell (approximately 20-30% lower). The cycle life (i.e., the number of times the battery can be recharged) of this battery is about 500 to 800 cycles, the self-discharge (i.e., loss of capacity on standing) per month is about 10%, and the cost is currently about $1.00 per Watt-hour (Wh) of energy. These batteries can be manufactured in near fully automated, high volume production. Although lithium ion battery technology is undergoing heavy commercialization currently, numerous safety issues have arisen, related to the use of the electrolytes at high voltages.

In the past two decades, many researchers have explored the possibility of combining two traditional lithium battery insertion or intercalation materials as an anode and cathode, to lower cell voltage, improve cell cylability, and reduce cell cost. However, this research has not yet led to cells that meet the expectations for commercialization, given the current popularity of the carbon anode/lithiated cobalt oxide cathode. An example is a TiS₂ anode combined with a LiCoO₂ cathode. The capacity of the TiS₂ electrode is only 226 mAh/g compared to 340 mAh/g for carbon. Hence, this battery would not be feasible commercially even for portable electronics applications as the energy density of the cell is 120 Wh/kg, even though the voltage of the cell is about 2.1 V.

Another type of system uses CO₃O₄ as the anode with capacities as high as 900 mAh/g, and LiCoO₂ as the cathode, of a lithium ion battery offering lower cell voltage than 3.7V. However, the energy density is not adequate, as the cathode capacity is now the limiting factor at about 140 mAh/g.

Rechargeable Lithium Ion Gelled Electrolyte Battery

A derivation of the lithium ion liquid electrolyte system is the lithium ion polymer electrolyte battery (system 6 in Table 1, above). Lithium ion cells utilizing gel electrolytes, i.e., a liquid organic solvent combined with a polymer, offer all the advantages of lithium ion liquid electrolyte cells. They are becoming widely commercialized by battery companies not only because they potentially offer good form factors for a large variety of consumer electronics devices, such as slim notebook computers and cellular telephones—but because they also offer improved safety over liquid electrolyte cells. The electrode chemistry is the same, but the liquid electrolyte (up to 70%) in this case is absorbed in a polymer membrane instead of the microporous polypropylene separator. One technology based on liquid organic solvents absorbed in polyvinylidene fluoride (PVDF) polymer was developed at Bellcore (see U.S. Pat. No. 5,296,318). The technology ensures good interfacial contact, which leads to relatively low internal cell resistance and, thus, good rate capability and long cycle life.

The current method of fabricating the polymer-solvent electrolyte involves a complex process in which PVDF is cast from a plasticizer solution of PVDF and DBP (di-butyl phthalate) to create some porosity for the liquid organic solvent. The DBP is then removed using either methanol or di-ethyl ether. The liquid organic solvent is then added to this polymer. This process is very expensive and involves hazardous chemicals.

Ironically, PVDF is non-conducting compared to traditional polymer electrolytes which are ionically conductive, and consequently merely holds the liquid organic solvents in its structure, similar to a sponge holding water. Because the technology uses an extensive amount of liquid electrolyte solvent absorbed in a polymer, it is not easy to manufacture cells at high speed. Automation may be very difficult. Furthermore, present lithium ion technology based on liquid organic solvents absorbed in PVDF polymer is inherently problematic. When gelled lithium ion battery technology emerged, form factors and flexibility were among its most praised features; but currently it is used to manufacture only flat prismatic cells that exhibit little flexibility. PVDF used in existing lithium ion gelled electrolyte batteries has numerous problems. These include instability at higher temperatures (dissolves in the solvents at about 60° C., thus losing separator properties); non-conductivity; swelling in contact with liquid organic solvents; loss of dimensional stability; poor electrode/electrolyte interface; and inability for manufacture in ultra-thin film forms, consequently resulting in lower energy density from the battery.

The gelled electrolyte cells incorporate very thick electrode/electrolyte structures (50-75 microns) onto metallic current collectors (25-50 microns) that not only add unnecessary weight and volume to the battery, but result in a lower cell performance. It is believed that many users incorporate an expanded gauze made of copper (anode) and aluminum (cathode) to coat the electrodes, instead of planar copper and aluminum foils. This adds more weight and volume to the already large percentage of inactive components of the cell. Furthermore, the use of organic carbonate-based electrolytes poses the same problems as liquid electrolyte lithium ion batteries.

In summary, the lithium metal anode rechargeable battery incorporating liquid organic solvent electrolytes is an abandoned system because of poor performance and safety issues, while the same anode technology incorporating a solid polymer electrolyte suffers from poor performance at temperatures below 60° C.

To date, the energy density of a lithium ion battery—whether the electrolyte is liquid organic solvents absorbed in a microporous separator, or a gel—is limited by the cathode capacity, which is about 140-150 mAh/g. Despite the fact that small cells (<C-size) are widely used for many consumer electronics applications, the performance and safety issues have been questioned for large cell applications. In addition, for many of the newer applications, the voltage of the battery is too high. The higher voltage chemistry requires the use of higher viscosity and hence electrochemically stable, but relatively lower conductivity electrolytes, which limits lower temperature operation. Also, the electrolyte is somewhat expensive compared to other liquid organic solvent electrolytes, and the battery incorporating such electrolytes has limited power capability and high self-discharge. A battery incorporating a lower voltage cathode would lead to a lower self-discharge and greater safety than the present high voltage lithium ion cells. The carbonate-based electrolytes further cause a unique safety concern in that during overcharge, the cathode decomposes somewhat, thereby releasing oxygen, which reacts with the carbonate electrolyte to form an explosive mixture. This necessitates controlled charging of each of the individual cells in a battery pack through external means. Unfortunately, the higher voltage of the chemistry prevents these batteries from utilizing redox chemical shuttles such as n-butyl ferrocene. The latter operates at lower voltages and prevents the voltage of the battery from attaining an overcharging beyond a value determined by the type of redox species used. Some of today's batteries are based on a soft-pack or pouch configuration. Present batteries incorporate either a polyethylene separator or a PVDF separator. PVDF appears to have some beneficial effect on the electrode/electrolyte interface. Although, other polymer materials such as polyacrylonitrile (PAN) or polymethylmethacrylate (PMMA), for example, offer interfacial properties superior to those of PVDF, they are electrochemically unstable at voltages above 4V and, therefore, are not used in existing lithium ion batteries. These adverse features or consequences of using such electrolytes and high voltage cathodes lead to poor energy density and poor power density, and, more importantly, poor safety. In the ten years since inception of lithium ion batteries, no major improvements in the cathode capacity or energy density have been made, and the average voltage has remained about 3.7V. Air-stable cathodes, such as those based on cobalt, nickel and manganese oxides are the only commercial cathodes. Furthermore, new cathode materials based on mixed-metal oxides result in battery energy densities of only about 175 Wh/kg,—not enough for most of the new enabling applications that require energy densities above 200 Wh/kg.

FIGS. 1a and 1b are schematic diagrams of a conventional (prior art) lithium ion battery incorporating traditional lithium ion anode and cathode and their reactions during initial charge (FIG. 1a) and the first discharge and subsequent charge and discharge cycles (FIG. 1b). As seen in FIG. 1a, the starting anode 10 is carbon and is lithium deficient, while the starting cathode 12 is rich in lithium content. The battery must be charged first, before it can be used to power a device. Since the battery is manufactured in a completely discharged state, with a cell voltage of zero volts, it is necessary for lithium ions to intercalate or insert into the carbon structure during charging. In the charged state, anode 10 becomes lithium rich, and cathode 12 is lithium deficient. Referring to FIG. 1b, upon the first discharge, the lithium exits the carbon structure and returns back to the cathode. The same events take place during each subsequent charge and discharge cycle.

FIGS. 2a and 2b are schematic diagrams of a conventional (prior art) lithium metal anode battery incorporating a non-lithiated insertion or intercalation cathode 22, and illustrating typical reaction during discharge and charge. In this case, the battery is fabricated in the charged state and can be used immediately to provide power in an electronic device. During the first and each subsequent discharge, the lithium from the lithium anode 20 oxidizes and enters the V₆O₁₃ lattice structure of cathode 22 (FIG. 2a). Upon the first subsequent charge (FIG. 2b) following battery depletion (and each subsequent charge in the pattern of discharge and charging cycles during use of the battery), the lithium ions exit from the V₆O₁₃ lattice structure and re-plate back onto the negative electrode (anode 20) as lithium metal. In this particular example, eight lithium ions are inserted into the vanadium oxide lattice of cathode 22 during discharge, but upon charge, only six lithium ions are reversible. It is well known that lithium metal is thermodynamically unstable in liquid organic solvents, and reacts upon contact. This is depicted in FIG. 2b as the formation of a passive layer 25 during repeated cycling. Layer 25 continues to grow upon each charge as fresh lithium is plated. For this reason, an excess capacity of lithium, i.e., 3-5 times that of the cathode, is used in such cells. As a practical matter, lithium metal anode batteries in liquid organic solvents are unsafe and no longer commercially available. Therefore, this example is merely intended to describe the typical reactions that occur upon discharge and charge of such a conventional, but now unavailable battery.

It is an objective of the present invention to provide a battery with exceptionally higher energy and power densities than presently available lithium ion cells, with tailored voltage, excellent reversibility, usable with a wide range of high dielectric constant and lower viscosity electrolytes, having an enhanced and stable polymer electrolyte interface with greater selection of the polymer materials, which is safe to use, and capable of production at relatively lower cost.

Another goal of the invention is to provide a battery with no compromises of safety as in the case of existing high voltage lithium ion batteries; manufacturable in larger formats for hybrid electric vehicles or electrically powered vehicles, for example; and not requiring controlled charging, but incorporating redox chemical shuttle species within the electrolyte that prevents overcharging of the battery.

The benefits of a low voltage, high energy battery become apparent when considering the many recent electronics applications that require lower voltage; the availability of higher dielectric constant, lower viscosity, and more conductive electrolytes that are usable at lower voltage, rather than the carbonates; the higher rate capability from higher conductivity electrolytes; and the advantage of safety attributable to lower voltage operation. All of these benefits are ideally suitable for electric vehicles, in terms of not only extended range, but higher power capability, greater cycle life, simplification of electronics in the case of a flatter discharge voltage, and lower cost.

The capacity of the anode is about three times that of the cathode in present lithium ion cells. Accordingly, it would be desirable if the cathode capacity were higher. Unfortunately, almost all the lithium insertion cathode materials commonly considered for lithium metal anode batteries, except those presently considered for the lithium ion batteries, i.e., lithiated cobalt, nickel and manganese oxides, are not lithiated materials but de-lithiated or without any reversible lithium. Except for the cobalt, nickel or manganese cathode compounds, lithiated compounds of other cathode materials are not available with reversible lithium in the lattice. Even if such materials were available, they would exhibit high moisture and air reactivity. Indeed, they have not been previously considered for lithium ion batteries; and lithiation of these cathodes outside a battery has not been well explored or documented sufficiently to be considered even at the research level.

A large number of insertion cathode materials offer promise for lithium ion batteries if made in the lithiated form and safely incorporated for a lithium ion cell. However, even if the lithiated materials of these other cathodes could be made in an inert atmosphere glove-box, manufacturing viability would be lacking for commercial cells because of the dangers of handling, the materials being chemically highly reactive and even deteriorating during processing, and cost of processing and handling in a glove-box environment being prohibitive.

### SUMMARY OF THE INVENTION

According to a preferred embodiment of the invention, a lithium ion battery comprises an anode consisting of a bonded combination of a lithium rich electrode overlying a carbon electrode in the initial manufactured state of the battery, and a lithium deficient cathode, the anode and the cathode being separated by an electrolyte. The initial manufactured state of the battery is a charged state. The reaction that occurs during the first discharge of the battery from its initial manufactured state results in substantially all of the lithium from the lithium electrode of the anode entering the lattice structure of the cathode, whereby the cathode is rendered lithium rich and the anode thereby consists virtually solely of the carbon electrode.

After the first discharge of the battery, in subsequent cycling of charges and discharges of the battery, the lithium is released from the cathode and enters the lattice structure of the carbon electrode without plating that electrode during the charging portion of each cycle, and the lithium in the anode is released therefrom to re-enter the lattice structure of the cathode during the discharge portion of each cycle. The reactions that occur in the battery during charge and discharge thereof are reversible. The amount of lithium contained in the overlying lithium electrode is selected such that substantially complete depletion of lithium from the anode and insertion of the thereby freed lithium into the cathode occurs upon the first discharge.

The cathode may be composed of a material selected from the group comprising vanadium oxide, lithium-deficient vanadium oxide, lithium-deficient manganese oxide, titanium sulfide, carbon polysulfide, and the like, or a combination thereof. The electrolyte separating the anode and the cathode is preferably selected from a group consisting of a solvent, a solid polymer, or a gel polymer. Other preferred cathode substrate materials are discussed below.

In operation of the lithium ion battery of the invention, since the battery exits the manufacturing process in a fully charged state, it is ready at that time for immediate discharge. During the first discharge, the lithium metal that is coated directly onto the carbon electrode portion of the anode oxidizes to form lithium ions, which insert into the cathode lattice structure (e.g., vanadium oxide (V₆O₁₃), to render the cathode lithium rich (e.g., as Li₈V₆O₁₃)). The discharge reaction results in all of the lithium metal entering the lattice structure of the cathode. Hence, no free lithium remains when the battery is in its completely discharged state. The carbon electrode portion of the anode remains unchanged, since it takes no part in the reaction occurring during the first discharge of the battery. That is, only the lithium metal portion of the anode is part of the first discharge reaction.

During subsequent charging of the now energy-depleted battery, the lithium metal ions are released from the lattice structure of the cathode to react with the anode. But instead of plating the anode, the lithium enters the carbon lattice structure of the anode. In cycling through subsequent discharges and charges, the battery operation corresponds closely to that of the conventional lithium ion battery of FIG. 1b. However, the lithium ion battery of the present invention has the advantages of being manufactured in a charged state, and without the presence of free lithium in contact with the electrolyte, and consequently, lacking the serious safety issues of lithium ion batteries of the prior art. The battery manufacturer is able to form the battery before shipment to the original equipment manufacturer (OEM), with no free lithium in the battery as delivered to the end-user.

Another important object of the present invention is to provide a method of manufacturing a lithium ion battery encompassing a variety of cathode materials with higher capacities and different voltages that can be tailored to the application of interest, compared to presently available lithium ion batteries.

Another object of the invention is to provide a method of manufacturing a lithium ion battery in which the starting cathode material is not a lithiated cathode or a lithiated cathode with non-reversible lithium in its lattice structure.

Yet another object of the invention is to provide a method of manufacturing a lithium ion battery in the charged state as opposed to the traditional manufacture in the discharged state.

Still another object of the invention is to provide a low voltage cathode for a lithium ion battery that is air and moisture stable and manufacturable under ambient conditions.

Another object of the invention is to provide a lithium ion battery that may be used with a variety of higher dielectric solvents with lower viscosities and greater conductivity than previously deemed possible.

Yet another object of the invention is to provide a lithium ion battery that is safer than existing lithium ion batteries.

Still another object of the invention is to provide a low voltage lithium ion battery that may be used with a variety of gel electrolytes.

Yet another object of the invention is to provide a lithium ion battery that is safer from electrolyte decomposition as a result of the lower voltage.

Another object of the invention is to provide a lithium ion battery that is lightweight and of relatively lower cost.

A further object of the invention is to provide a lithium ion battery tailored voltage discharge, i.e., flat versus sloping discharge with respect to time.

Yet another object of the invention is to provide a lithium ion battery with a lower voltage and lower self-discharge.

Still another object of the invention is to provide a lithium ion battery with an overcharge redox shuttle.

Another object of the invention is to provide a lithium ion battery with higher energy and power densities than presently available batteries.

### BRIEF DESCRIPTION OF THE DRAWING

The above and other objects, features and attendant advantages of the invention will become more apparent from a consideration of the following detailed description of the currently contemplated best mode of practicing the invention, by reference to certain preferred embodiments and methods of carrying out the concepts of the invention, taken in conjunction with the accompanying drawings, in which:

FIGS. 1a and 1b are schematic diagrams of a conventional (prior art) lithium ion battery incorporating traditional lithium ion anode and cathode, illustrating its different states of charged and discharge, the battery having been manufactured in a completely discharged state, and the reactions that take place during charge and discharge, described in the Background section, above.

FIGS. 2a and 2b are schematic diagrams of a conventional (prior art) lithium metal anode battery incorporating a non-lithiated insertion or intercalation cathode, illustrating typical reactions during discharge and charge, also described in the Background section, above.

FIGS. 3a and 3b are schematic diagrams that illustrate the different states of charge and discharge of a presently preferred embodiment of the present invention.

FIG. 4 is a voltage-time charge and discharge curve for a typical conventional lithium ion battery comprising a carbon anode and a lithiated cobalt oxide cathode activated immediately upon manufacturing.

FIG. 5 is an example of the voltage-time discharge and charge curve for a lithium ion battery embodiment according to the present invention, comprising a carbon/lithium metal anode and a V₆O₁₃ cathode, the cell being in its activated state for use immediately upon completion of manufacture, to power a host device.

FIG. 6 is an illustrative example, in fragmented perspective view of exaggerated dimensions, of a metallized plastic substrate for lithium ion cells according to the principles of the present invention.

FIG. 7 is an illustrative example, in side view, of a large format battery constructed of lithium ion cells according to the principles of the present invention.

### DESCRIPTION OF THE CURRENTLY CONTEMPLATED BEST MODE OF PRACTICING THE INVENTION

According to a first aspect of the present invention, an electrochemical cell is provided having improved performance, in which the cell has a liquid electrolyte absorbed in a microporous separator or gel electrolyte, or a solid polymer electrolyte that separates a unique anode and the cathode of the cell. Each of the anode and cathode is selected from a group that exemplifies a very high capacity for maximizing the energy density. The active cathode may be selected from a wide range of oxides, sulfides and selenides, or any other group well known in the prior art, e.g., LiₓMn₂O₄, LiₓMnO₂, LiₓCoO₂, V₂O₅, V₆O₁₃, V₅S₈, TiS₂, LiₓV₃O₈, V₂S₅, NbSe₃, LiₓNiO₂, LiₓNi_{y}Co_{z}O₂, LiₓNi_{y}Mn_{z}O₂, LiₓCo_{y}Mn_{z}O₂, MoS₂, chromium oxides, molybdenum oxides, niobium oxides, electronically conducting polymers such as polypyrrole, polyaniline, polyacetylene, and polyorganodisulfides such as poly-2,5-dimercaptol,3,4-thiadiazole, and numerous other forms of organosulfides, and so forth. By way of example but not of limitation, the active anode may be selected from the group including tin oxide, lithium ion-insertion polymers, lithium ion-insertion inorganic electrodes, and carbon insertion electrodes. In addition, the active anode comprises lithium metal in which a thin metal foil or layer of lithium may be plated or laminated or otherwise coated or deposited directly onto the anode. The capacity of the lithium metal should be set to balance the capacity of the cathode for lithium uptake, which must balance the capacity of the carbon anode. If lithium metal is not used, then a lithium-rich or lithium intercalated material anode may be used instead, as a portion of the anode. This would serve the same purpose as the lithium metal.

The electrolyte for such a cell need not be restricted to the organic carbonates but can be extended to include any electrolytes traditionally considered for lithium metal anode rechargeable batteries, or solid polymer electrolytes as described in U.S. Pat. No. 6,413,676, or gel electrolytes, e.g., the anode and cathode are separated by an electrolyte absorbed in a microporous separator, or by a free-standing electrolyte. If the lithium ion is a liquid electrolyte battery, then the separator may consist of either a microporous polyethylene or polypropylene or layers of polyethylene/polypropylene.

The advantages of such a battery become apparent when one considers the use of conventional high capacity lithium battery cathodes, the use of a wider selection of organic solvent electrolyte as well as solid polymer and gel polymer electrolytes, and anodes with higher capacities than traditional carbon-based graphites commonly used in lithium ion batteries. The cathode of this battery is either non-lithiated or lithium-deficient. The cathode materials are air and moisture stable. In addition, for what appears to be the first time, the battery manufacturer has a wider selection of the cathode chemistry than was available before. The cathode chemistry may be tailored to suit the intended application. For example, an application requiring a flat and low voltage discharge would use a TiS₂ cathode, e.g. cell voltage of 2.1 V, while an application that requires high energy content would use a V₆O₁₃ cathode, which has a specific capacity of 420 mAh/g or a polyorganodisulfide cathode such as (SCH₂CH₂S)—ₙ, which has a capacity of 580 mAh/g.

The use of high capacity cathodes now allows use of high capacity anodes in the lithium ion battery construction of this invention. Conventional lithium ion anodes comprise carbon or graphite materials with specific capacities of about 340 mAh/g. However, other materials being investigated offer higher capacities such as tin oxides and CO₃O₄ with capacities of 700 mAh/g and 1000 mAh/g, respectively and hard carbon with capacities of about 750 mAh/g.

The lithium metal foil or layer that, in part, comprises the anode is tailored to suit the capacity of the cathode and anode. The lithium may be laminated, coated, or calendered with the anode of the lithium ion battery.

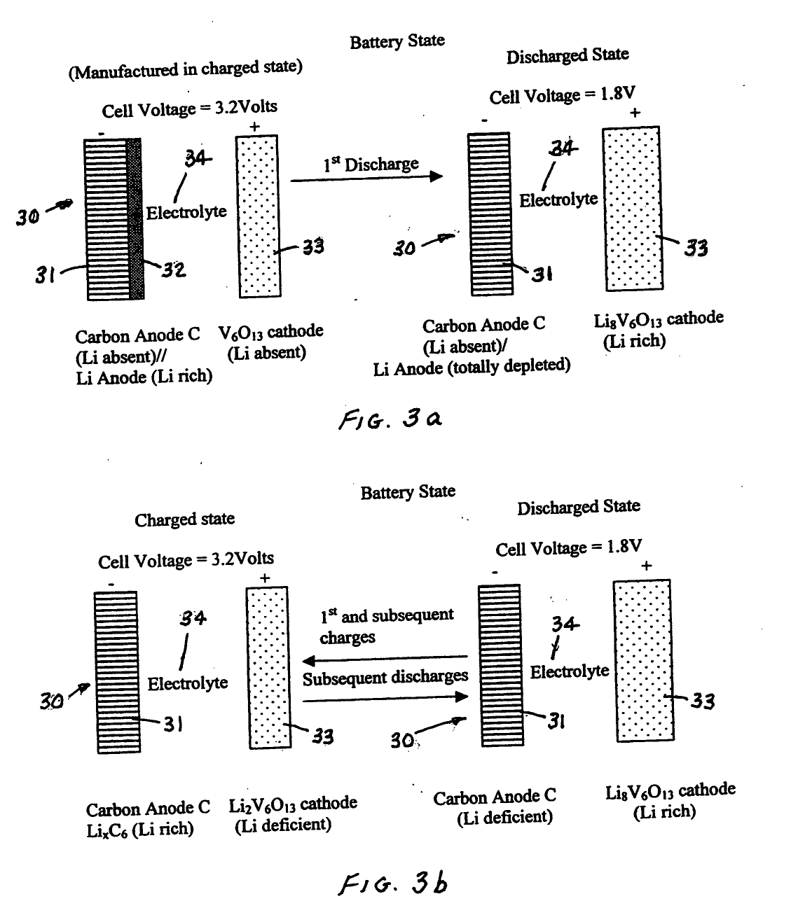

The cell reaction proceeds as described in the schematic diagrams of FIGS. 3a and 3b, of which more will be described presently herein. Since lithium metal is used as part of the anode along with, say carbon and a non-lithiated cathode such as V₆O₁₃, the initial cell voltage is about 3.2 V. Initially, the cell can be construed as a lithium metal anode battery. The cell is fabricated in the charged state. Upon discharge, the lithium metal oxidizes to form lithium ions and migrates to the cathode under the influence of an electric field to intercalate into the cathode structure as Li₈V₆O₁₃. At this stage, the lithium metal is totally consumed leaving the carbon anode intact and a Li₈V₆O₁₃ cathode. Upon charge, the lithium ions exiting the cathode now enter the carbon lattice of the anode and the battery behaves as a typical lithium ion battery. Upon charge, however, only 6 reversible lithiums leave the cathode to insert into the carbon. Subsequent discharge and charge reactions are similar to a lithium ion battery and no lithium plating occurs as it does in the case of a traditional lithium anode battery, since no free lithium ions exist after the first discharge. Despite the use of lithium metal, there is no subsequent plating reaction that occurs or any lithium to form a passive layer.

Lithium primary battery electrodes are traditionally made by calendaring the cathode paste onto a nickel or stainless steel gauze and compacting between heated rollers. In the case of lithium metal anodes the gauze is used as a substrate material. The substrate material is typically about 2 to 3 mils thick. The anode and cathode are typically about 5 to 10 mils thick, with a microporous polypropylene separator sandwiched between them, and wound in a jelly-roll manner. Usually, the laminates are very thick and the electrode length is about two feet in a typical AA size cell. Rechargeable lithium metal anode batteries were also constructed in this manner.

These techniques have changed considerably with the advent of lithium ion battery construction. The carbon anode, for example, is pasted in relatively thin film form onto a copper foil electrode, and the lithiated metal oxide cathode is pasted onto an aluminum foil. The substrate thickness for both anode and cathode is in a range from about 25 to 35 microns, and the active electrode is about 25 microns thick. Additionally, the length of each electrode in a typical AA size cell is about twice that of lithium anode cells. Present electrode/electrolyte component thickness in gelled electrolyte lithium ion cells is of the order of 50 to 75 microns each.

Thick inactive substrates used in such cell construction effectively reduce the energy density of the battery. In addition, this design exposes the cells to risk of high polarization during charge and discharge, which could lead to breakdown of the liquid solvent electrolyte and consequently loss of capacity, loss of cycle life and inadequate safety.

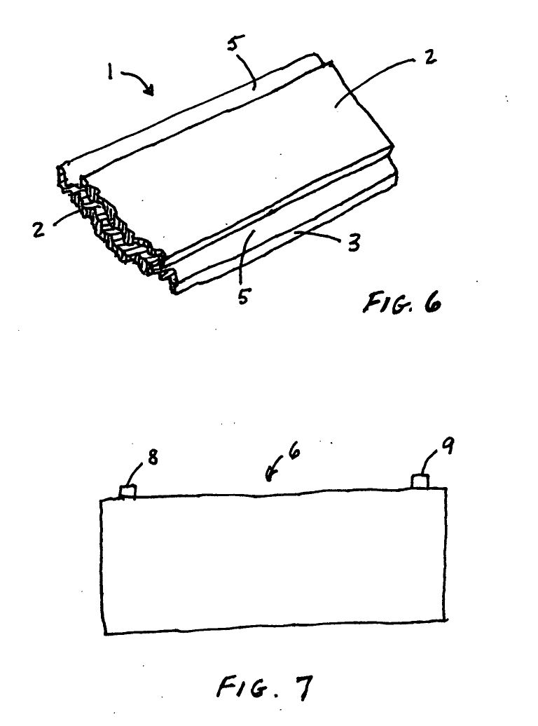

In yet another of its aspects, the present invention incorporates a metallized plastic substrate (FIG. 6) in a preferred thickness less than 10 microns. Preferably, the metallized plastic layer 1 comprises an ultra thin (e.g., significantly less than 1.0 micron) metal layer 2 of aluminum or copper adhered to one side, or preferably, both sides of a polymer substrate 3. The advantage of a thinner substrate is that more active components can be incorporated in the same package resulting in higher energy density. The present invention preferably uses metal layers of thickness ranging upward from about 0.01 micron, e.g., a copper layer thermally deposited onto a polymer substrate of either polyethylene terphthalate (PET), polypropylene (PP), polyphenylene sulfide (PPS), polyethylene naphthalate (PEN), polyvinylidene fluoride (PVDF) or polyethylene (PE), or a combination of two or more thereof, for the anode. An ultra thin metal layer, e.g., aluminum, is thermally deposited or otherwise coated onto such a polymer substrate for the cathode. See, e.g., U.S. Pat. No. 6,413,676. The thickness of each metal layer depends on the conductivity requirement and the desired resistivity of the metal. The polymer substrate may have a layer thickness in a range from about 0.5 micron to greater than about 50 microns, for example.

Each polymer substrate electrode material has different characteristics and thermal and mechanical properties, and each behaves differently depending upon its use. Ideally, the thickness of the metal coating should be kept as thin as possible, while concurrently ensuring that its conductivity is very high. Preferably, the coating thickness provides a resistivity of 0.1 ohm per square, and more preferably 0.01 ohm per square. This will ensure low resistance loss during current drain from the metallized substrate. The metallization is preferably done on both sides of the polymer film substrate. Further, the metallization preferably is accomplished to leave an unmetallized margin 5 at opposite edges of the width of the respective anode and cathode webs, so that when the substrate is coated with the active material, the coating material will be applied to the metallized portion and not the margin.

Reference is again made to FIGS. 3a and 3b, schematic diagrams that illustrate a presently preferred exemplary embodiment of the present invention in its different states. In contrast to conventional lithium ion batteries, which are manufactured in the discharged state and must be charged before they can be used to power a host device, the lithium ion battery of the present invention is manufactured in the charged state. By way of example and not limitation of the invention, the anode 30 in its originally or initially manufactured state, which is a charged state, comprises a typical carbon electrode 31, but which is plated, laminated or otherwise coated with a lithium metal electrode 32, i.e., the anode 30 is initially a bonded combination of carbon 31 and lithium 32. The cathode 33 in the battery of the invention is a non-lithiated material or lithium-deficient material (e.g., capable of accepting reversible lithium into its structure). The latter may include a material selected from a group such as vanadium oxide, lithium deficient vanadium oxide, lithium-deficient manganese oxide, titanium sulfide, carbon polysulfide, and the like, or a combination thereof. In the exemplary embodiment schematically illustrated in FIGS. 3a and 3b, the selected material of the cathode is vanadium oxide. The anode 30 and cathode 33 are separated by an electrolyte 34.

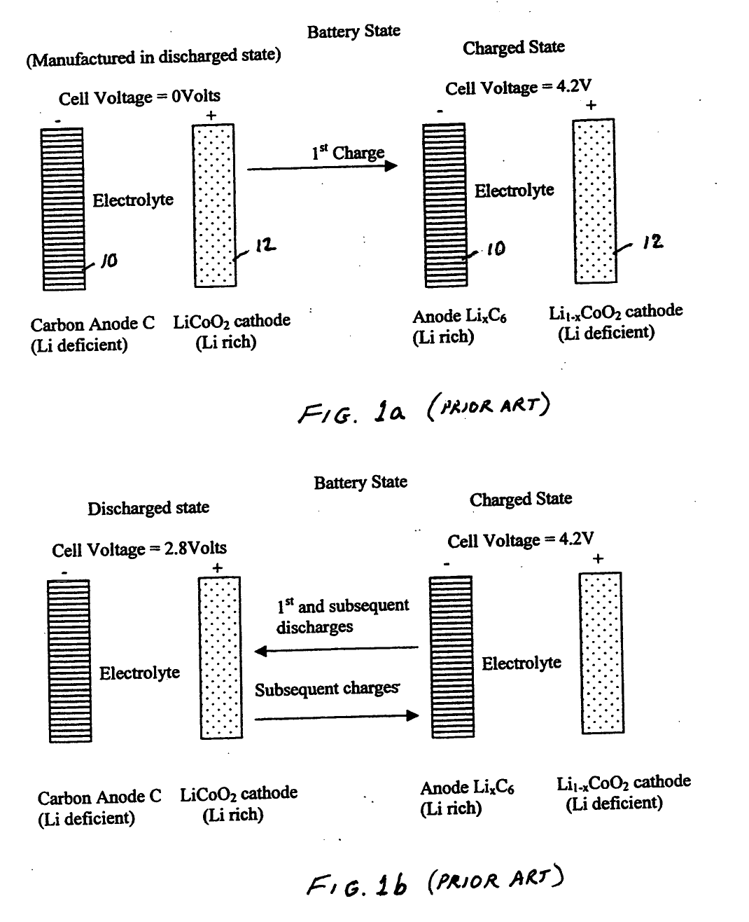

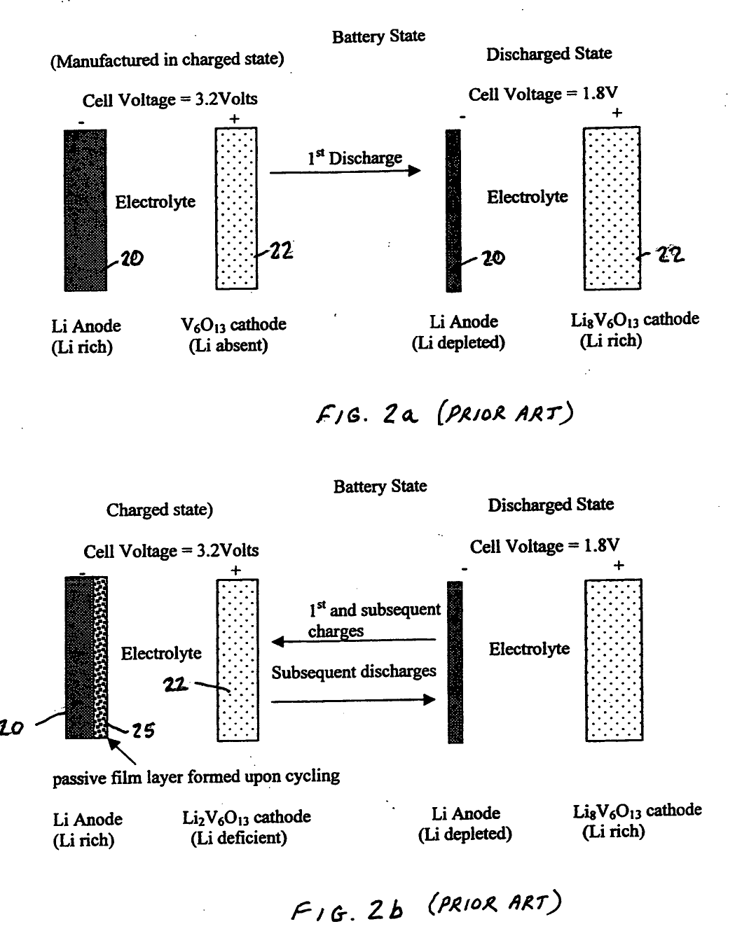

The non-lithiated or lithium-deficient cathode 33 of the battery of the invention (FIGS. 3a and 3b, charged state) is to be distinguished from the traditional cathode of a conventional lithium ion battery (e.g., FIGS. 1a and 1b), which is lithiated or lithium-rich and contains reversible lithium in its lattice. The non-lithiated or lithium-deficient cathode is comparable to the resulting cathode material of the conventional lithium ion battery at end of charge (i.e., in the charged state), such as Li₁₋ₓCoO₂, while the material of the lithiated cathode is comparable to the cathode material of the conventional lithium ion battery at the beginning of charge (i.e., from a discharged state, as the battery exists at the end of the manufacturing process) and which is air-stable, e.g. LiCoO₂. In one of its aspects, the invention provides a means by which a lithiated cathode is formed in a lithium ion battery when the battery is first discharged from its initial charged state.

With reference to FIG. 3a, the lithium ion battery is manufactured in the charged state. During the first discharge, the lithium metal 32 that is coated directly onto the carbon electrode portion 31 of anode 30 oxidizes to form lithium ions, analogous to the formation of lithium anodes during first discharge of the conventional battery of FIG. 2a. These lithium ions insert into the vanadium oxide (V₆O₁₃) cathode lattice structure as Li₈V₆O₁₃. Unlike the formerly commercially available battery structure of FIG. 2a, however, in the lithium ion battery of FIG. 3a all of the lithium metal is reacted into the vanadium oxide structure of cathode 33 so that no free lithium remains when the battery is in the fully discharged state. The carbon electrode 31 remains unchanged, having taken no part in the first discharge (i.e., only the plated, laminated or otherwise coated lithium metal layer 32 electrode portion of the anode 30 is part of the first discharge reaction).

Upon subsequent charging of the battery (FIG. 3b), the lithium metal exits the vanadium oxide lattice structure of cathode 33, but instead of plating the anode as lithium metal as in the conventional battery of FIG. 2b, the lithium enters the carbon anode lattice as in the conventional lithium ion battery of FIG. 1a. The battery of the invention is then able to cycle back and forth from a charged state to a discharged state when in use, in the same way as the conventional lithium ion battery of FIG. 1b, but with the advantages of having been manufacturable in a charged state, and without the very serious safety issues that have caused the conventional lithium ion battery of FIG. 2b to disappear from the marketplace. By virtue of the invention, the manufacturer of the applicant's battery can now simply “form” the battery before shipping to original equipment manufacturers (OEMs), so that no free lithium is present in the battery delivered to the end-user.

The voltage of this embodiment of the battery is significantly lower than that of commercially available conventional lithium ion cells (e.g., 3.2 V vs. 4.2 V, respectively). Hence, its electrolyte 34 may be chosen from a wide selection of materials, including lower viscosity solvents to solid polymer electrolytes to gel polymer electrolytes.

The lithium metal capacity is designated for balancing to equal both the anode and the cathode capacity. Upon initial discharge, the lithium oxidizes to lithium ions, and reacts reversibly with the cathode, i.e. the vanadium oxide is lithiated in-situ, leaving the carbon anode, which is not involved in this reaction, intact. Subsequent charge and discharge reactions occur in a manner similar to the reactions that take place in a conventional lithium ion battery. That is to say, upon charge of the battery, the lithium ions from the now lithium rich cathode 33 insert into the carbon structure 31 of anode 30. The amount of lithium that is plated or laminated or otherwise coated on the anode 30 is specifically chosen so that upon the first complete discharge, the lithium is completely depleted from the anode 30 and inserted into the cathode 33, which renders the latter lithium rich. Upon full charge, the reversible lithium ions exit the cathode structure and, instead of coating the carbon electrode 31 with metallic lithium, these ions enter the carbon lattice of anode 30 in a manner similar to what takes place during the charging reaction a conventional lithium ion battery (FIG. 1a). In each cycle, the discharge must be full or complete so that the lithium metal is completely depleted, and the charge must be full or complete since some lithium in the cathode remains as irreversible, and that remaining lithium needs to be fully inserted in the carbon upon charge.

Since lithium metal is exposed to the electrolyte 34 for only the first discharge and all the lithium metal 32 on the carbon electrode 31 of anode 30 is liberated during that first discharge reaction, the problem of lithium re-plating that takes place in the formerly available conventional lithium anode battery of FIGS. 2a and 2b does not exist in the battery of the present invention. The chemical consumption of metallic lithium in contact with the electrolyte is minimal and does not appreciably affect the battery capacity, similar to the case of a primary lithium metal battery. In fact, if the battery of the invention were discharged from its initially charged state immediately after manufacture, this consumption would be negligible.

Lithium ion batteries constructed and processed as above allows the use of cathode materials that were not possible with previous technology. The new concept battery chemistries provide a domino effect on performance. More importantly, manufacturability is nearly identical to that for existing lithium ion batteries. The cathode chemistry may be tailored to suit the intended application and in some cases the battery may be manufactured as a drop-in replacement to an existing battery used in a device. Presently, this is not possible with conventional lithium ion batteries, as the voltage of this battery is fixed at 3.7 V. Also an application requiring a flat discharge would, for example, use an MnO₂ cathode, e.g. with an average cell voltage of 2.8 V and a specific cathode capacity of 310 mAh/g, while an application that requires high energy content but lower voltage would, for example, use a V₆O₁₃ cathode, which has a specific capacity of 420 mAh/g.

The invention opens up the potential use of cathode materials with exceptionally high capacities compared to capacities previously available for lithium ion batteries, and, when combined with high capacity anodes such as hard carbon and tin oxides, with capacities exceeding 700 mAh/g, leads to very high energy and power densities. Furthermore, the invention allows the use of lower viscosity electrolytes, which are more conductive than organic carbonates, as well as being cheaper and safer. The use of lower voltage but very high capacity cathodes is expected to yield lower self-discharges from the cell. By allowing lower viscosity liquid electrolytes, the new lithium ion battery may now use PAN or PMMA-based polymer electrolytes or any other polymer electrolytes or coatings of polymer electrolytes onto existing separator materials which are electrochemically stable under the operating voltages.

By incorporating, for example, a PAN-based polymer with liquid organic solvents such as 2-methyl tetrahydrofuran, a true lithium ion polymer electrolyte system can be developed with enhanced safety and a broad range of flexibility in battery manufacturing.

In addition, the new battery need not incorporate special charging protocols as traditional lithium ion batteries require since the voltage of the new batteries are below 4.2 V. By allowing lower viscosity electrolytes, the new lithium ion battery allows the use of redox overcharge shuttles within the electrolyte, such as n-butyl ferrocene, to control the overcharge—instead of using special external circuitries to control the overcharging reactions.

Lithium ion batteries of this design can be combined with various high capacity negative electrodes or anodes such as ion-insertion polymers, ion-insertion inorganic electrodes, carbon insertion electrodes, tin oxide electrodes, or lithium nitrides, among others, combined with a lithium electrode and with various high capacity positive electrodes such as ion-insertion polymers, ion-insertion inorganic electrodes, and other lithium reversible cathodes, to provide batteries having exceptionally high specific energy (Wh/kg) (gravimetric) and energy density (Wh/l) (volumetric), tailored voltage, high cycle life, low self-discharge, and which provide improved safety. The solution provided by the present invention enables the use of large format lithium ion batteries that are safe, and ideal for hybrid automotive and space applications. Such a large format lithium ion battery 6 is illustrated in the side view of FIG. 7, appearing much like a conventional lead-acid battery, e.g., of rectangular block shape having dimensions of about 8 inch height, 6 inch width, and 10 inch length, with positive terminal 8 and negative, or electrical ground, terminal 9 projecting from the top of the battery.

The above and other embodiments of the invention, which leads to improved cell performance, become more apparent from a consideration of the following examples of cell construction, the first of which describes a conventional cell in contrast to the other examples.

### EXAMPLE 1

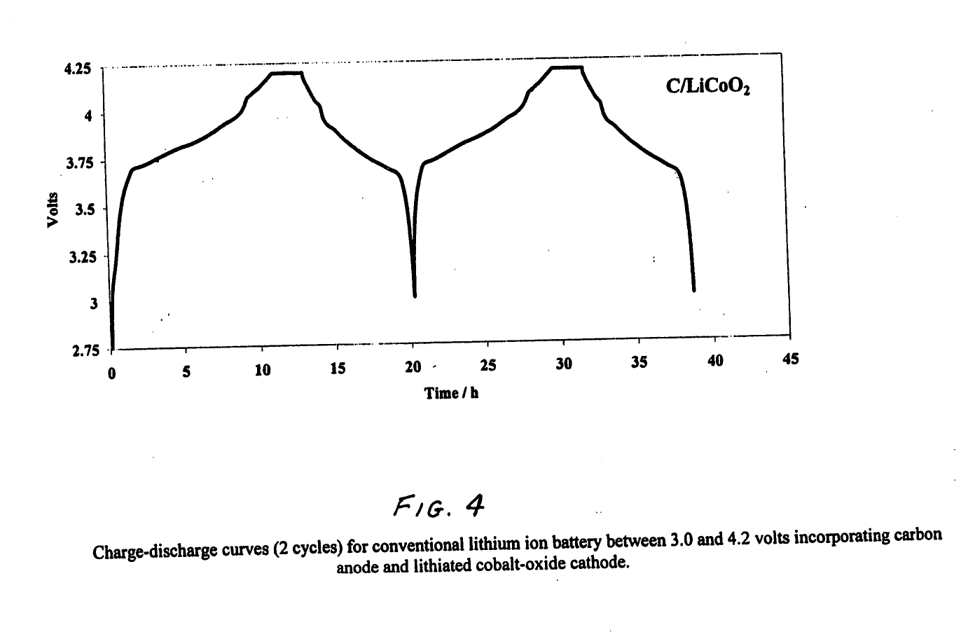

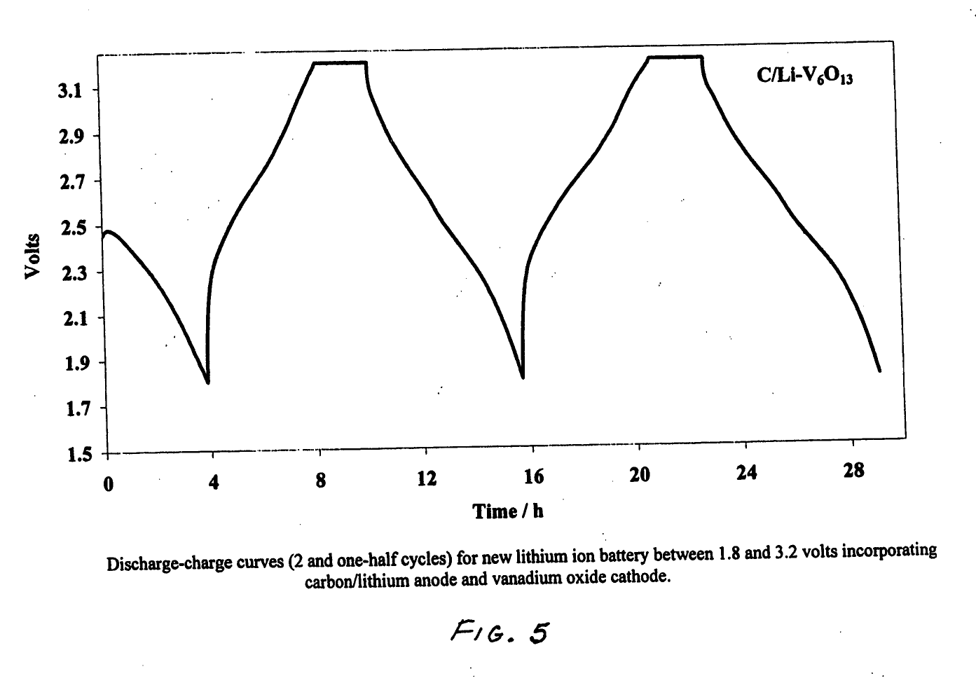

A conventional lithium ion battery is typically constructed with a graphitic carbon anode with a specific capacity of 340 mAh/g and an electrode thickness of 55 microns on either side of a 10 micron copper current collector. This is combined with a lithiated cobalt oxide cathode with a specific capacity of 140 mAh/g and an electrode thickness of 60 microns on either side of a 20 micron aluminum current collector. The separator between anode and cathode is a 33 micron thick microporous polyethylene and an electrolyte comprising of 1:1 EC:PC containing 1 molar LiPF₆. The components are stacked as coupons, like electrodes welded together, in a soft-pack cell phone battery configuration with dimensions 35 mm×64 mm×3.6 mm. A battery of this conventional design has a charge-discharge profile as depicted in FIG. 4. The average cell voltage of this battery is 3.7 V with top-of-charge being 4.2 V and end-of-discharge voltage of 3 V. The specific energy of this battery is 162 Wh/kg. The charge-discharge profile of FIG. 4 is to be compared with the typical discharge-charge profile of FIG. 5 for the lithium ion battery embodiments of the invention described in Examples 2-22, below.

### EXAMPLE 2

In this example of the invention, the anode is a graphitic carbon with a capacity of 340 mAh/g and an electrode thickness of 110 microns on either side of a 10 micron copper current collector. The anode is further laminated with a layer of lithium metal of 31 micron thickness. The lithium thickness, and hence its capacity, is chosen to balance that of the cathode. The cathode is V₆O₁₃ with a specific capacity of 420 mAh/g and an electrode thickness of 38 microns on either side of a 20 micron aluminum current collector. The separator is a 33 micron thick microporous polyethylene and an electrolyte comprising of 1 molar LiAsF₆ in 1:1 propylene carbonate (PC):dimethoxyethane (DME). The components are stacked as coupons, like electrodes welded together, in a soft-pack cell phone battery configuration with dimensions 35 mm×64 mm×3.6 mm. A battery of this design has a discharge-charge profile as depicted in FIG. 5. The average cell voltage of this battery is 2.4 V with top-of-charge being 3.2 V and end-of-discharge voltage of 1.8 V. The specific energy of this battery is 187 Wh/kg.

### EXAMPLE 3

The battery of Example 2, when combined with a separator thickness of 9 microns, yields and energy density of 198 Wh/kg.

### EXAMPLE 4

Using the same thickness separator of Example 3 in Example 1 yields an energy density for the conventional lithium ion to be 170 Wh/kg.

### EXAMPLE 5

The battery of Example 3, when replaced by 10 micron thick metallized plastic current collectors instead of metal current collectors, yields an energy density of 222 Wh/kg.

### EXAMPLE 6

The battery of Example 2, when the graphitic carbon is replaced by hard carbon with a specific capacity of 750 mAh/g, yields an anode thickness of 55 microns on either side of the 10 micron copper current collector, a lithium layer on the anode of thickness 39 microns, and a cathode thickness of 47 microns on either side of the 20 micron aluminum current collector. The energy density of this battery is 260 Wh/kg in the same cell phone soft-pack configuration as Example 2.

### EXAMPLE 7

In this example of the invention, the anode is a graphitic carbon with a capacity of 340 mAh/g and an electrode thickness of 110 microns on either side of a 10 micron copper current collector. The anode is further laminated with a layer of lithium metal of 23 micron thickness. The lithium thickness and hence its capacity if chosen to balance that of the cathode. The cathode is TiS₂ with a specific capacity of 226 mAh/g and an electrode thickness of 59 microns on either side of a 20 micron aluminum current collector. The separator is a 33 micron thick microporous polyethylene and an electrolyte comprising of 1 molar LiAsF₆ in tetrahydrofuran (THF)/2-methyl tetrahydrofuran (2-Me-THF). The components are stacked as coupons, like electrodes welded together, in a soft-pack cell phone battery configuration with dimensions 35 mm×64 mm×3.6 mm. The average cell voltage of this battery is 2.8 V with top-of-charge being 3.0 V and end-of-discharge voltage of 2.6 V. The specific energy of this battery is 198 Wh/kg.

### EXAMPLE 8

The battery of Example 7 when combined with a separator thickness of 9 microns yields an energy density of 208 Wh/kg.

### EXAMPLE 9

The battery of Example 8, when replaced by 10 micron thick metallized plastic current collectors instead of metal current collectors, yields an energy density of 227 Wh/kg.

### EXAMPLE 10

The battery of Example 7, when the graphitic carbon is replaced by hard carbon with a specific capacity of 750 mAh/g, yields an anode thickness of 55 microns on either side of the 10 micron copper current collector, a lithium layer on the anode of thickness 29 microns, and a cathode thickness of 74 microns on either side of the 20 micron aluminum current collector. The energy density of this battery is 262 Wh/kg in the same cell phone soft-pack configuration as Example 2.

### EXAMPLE 11

In this yet another example of the invention, the anode is a graphitic carbon with a capacity of 340 mAh/g and an electrode thickness of 110 microns on either side of a 10 micron copper current collector. The anode is further laminated with a layer of lithium metal of 23 micron thickness. The lithium thickness, and hence its capacity, is chosen to balance that of the cathode. The cathode is LiV₃O₈ with a specific capacity of 280 mAh/g and an electrode thickness of 48 microns on either side of a 20 micron aluminum current collector. The separator is a 33 micron thick microporous polyethylene and an electrolyte comprising 1 molar LiPF₆ in 1:1 PC/DME. The components are stacked as coupons, like electrodes welded together, in a soft-pack cell phone battery configuration with dimensions 35 mm×64 mm×3.6 mm. The average cell voltage of this battery is 2.8 V with top-of-charge being 3.4 V and end-of-discharge voltage of 2.2 V. The specific energy of this battery is 197 Wh/kg.

### EXAMPLE 12

The battery of Example 11, when combined with a separator thickness of 9 microns, yields and energy density of 208 Wh/kg.

### EXAMPLE 13

The battery of Example 12, when replaced by 110 micron thick metallized plastic current collectors instead of metal current collectors, yields an energy density of 225 Wh/kg.

### EXAMPLE 14

The battery of Example 11, when the graphitic carbon is replaced by hard carbon with a specific capacity of 750 mAh/g, yields an anode thickness of 55 microns on either side of the 10 micron copper current collector, a lithium layer on the anode of thickness 29 microns, and a cathode thickness of 60 microns on either side of the 20 micron aluminum current collector. The energy density of this battery is 287 Wh/kg in the same cell phone soft-pack configuration as Example 2.

### EXAMPLE 15

In this still another example of the invention, the anode is a graphitic carbon with a capacity of 340 mAh/g and an electrode thickness of 110 microns on either side of a 10 micron copper current collector. The anode is further laminated with a layer of lithium metal of 23 micron thickness. The lithium thickness, and hence its capacity, is chosen to balance that of the cathode. The cathode is a polyorganosulfide named 2,5-dimercapto 1,3,4-dithiazole with a specific capacity of 360 mAh/g and an electrode thickness of 82 microns on either side of a 20 micron aluminum current collector. The separator is a 33 micron thick microporous polyethylene and an electrolyte comprising of 1 molar LiCF₃SO₃ in diglyme The components are stacked as coupons, like electrodes welded together, in a soft-pack cell phone battery configuration with dimensions 35 mm×64 mm×3.6 mm. The average cell voltage of this battery is 2.8 V with top-of-charge being 3.0 V and end-of-discharge voltage of 2.6 V. The specific energy of this battery is 201 Wh/kg.

### EXAMPLE 16

The battery of Example 15, when combined with a separator thickness of 9 microns, yields and energy density of 211 Wh/kg.

### EXAMPLE 17

The battery of Example 16, when replaced by 10 micron thick metallized plastic current collectors instead of metal current collectors, yields an energy density of 237 Wh/kg.

### EXAMPLE 18

The battery of Example 15, when the graphitic carbon is replaced by hard carbon with a specific capacity of 750 mAh/g, yields an anode thickness of 55 microns on either side of the 10 micron copper current collector, a lithium layer on the anode of thickness 29 microns, and a cathode thickness of 103 microns on either side of the 20 micron aluminum current collector. The energy density of this battery is 306 Wh/kg in the same cell phone soft-pack configuration as Example 2.

### EXAMPLE 19

This is another example of the invention, in which the anode is a graphitic carbon with a capacity of 340 mAh/g and an electrode thickness of 110 microns on either side of a 10 micron copper current collector. The anode is further laminated with a layer of lithium metal of 23 micron thickness. The lithium thickness, and hence its capacity, is chosen to balance that of the cathode. The cathode is a polyorganosulfide named trithiocyanuric acid with a specific capacity of 460 mAh/g and an electrode thickness of 72 microns on either side of a 20 micron aluminum current collector. The separator is a 33 micron thick microporous polyethylene and an electrolyte comprising of 1 molar LiCF₃SO₃ in diglyme The components are stacked as coupons, like electrodes welded together, in a soft-pack cell phone battery configuration with dimensions 35 mm×64 mm×3.6 mm. The average cell voltage of this battery is 3 V with top-of-charge being 3.2 V and end-of-discharge voltage of 2.6 V. The specific energy of this battery is 245 Wh/kg.

### EXAMPLE 20

The battery of Example 19, when combined with a separator thickness of 9 microns, yields and energy density of 255 Wh/kg.

### EXAMPLE 21

The battery of Example 20, when replaced by 10 micron thick metallized plastic current collectors instead of metal current collectors, yields an energy density of 275 Wh/kg.

### EXAMPLE 22

The battery of Example 19, when the graphitic carbon is replaced by hard carbon with a specific capacity of 750 mAh/g, yields an anode thickness of 55 microns on either side of the 10 micron copper current collector, a lithium layer on the anode of thickness 29 microns, and a cathode thickness of 90 microns on either side of the 20 micron aluminum current collector. The energy density of this battery is 353 Wh/kg in the same cell phone soft-pack configuration as Example 2.

The above examples clearly demonstrate the benefits of the invention including higher specific energies for the examples cited, to cite a few, and lower voltage—desirable for several reasons—good for electronics; a wider selection allowed in the use of low viscosity and safer electrolytes; use of redox couples allowed, to protect from overcharge as opposed to complex protection circuitry in conventional present-day lithium ion chargers; and greater overall battery safety.

Such features of the present invention have the potential to enable viable electric vehicles, with a driving range exceeding 300 miles on a single charge. The invention also has the potential to enable further miniaturization of portable electronics, or of extending the run-time of such devices, or both.

A presently contemplated best mode of practicing the invention has been set forth in this specification, by reference to certain preferred embodiments and methods of manufacture of the invented lithium ion battery, but it will be apparent to those skilled in the art to which the invention pertains, from a consideration of the description, that variations and modifications of those embodiments and methods may be made without departing from the spirit or scope of the invention. It is intended that the invention be limited only to the extent of the claims and the law applicable thereto.

1. A lithium ion battery, comprising, in the initial manufactured state of the battery, an anode structured of a lithium metal electrode overlying and bonded to a lithium-deficient carbon electrode, a lithium deficient cathode, and an electrolyte separating said anode and said cathode, wherein the amount of lithium metal in said lithium metal electrode is substantially equivalent to the capacity of said lithium-deficient cathode to absorb lithium during discharge of said battery, whereby to preclude highly reactive contact of free lithium with said electrolyte during and after manufacture of the battery, said initial manufactured state of said battery being a charged state.

2. (canceled)

3. The lithium ion battery of claim 1, wherein in the discharged state of said battery, said anode consists substantially solely of said lithium-deficient carbon electrode and is devoid of said lithium metal electrode, and said cathode is lithium rich from occlusion of lithium of the former said lithium metal electrode into the lattice structure of said cathode during discharge of said battery, the amount of lithium in said cathode when the battery is in its discharged state being sufficient to completely occlude into said carbon electrode on subsequent charging of said battery.

4. The lithium ion battery of claim 3 comprising, in each subsequent charge state following a discharge state of the battery, said cathode being lithium-deficient and said anode having substantially all of the lithium released by said cathode during charging of said battery in the lattice structure of the carbon of said anode, with substantially no plating of said anode by the lithium released from the cathode.

5. (canceled)

6. (canceled)

7. The lithium ion battery of claim 1, wherein said cathode is composed of a material selected from the group consisting of oxides, sulfides, selenides, LiₓMn₂O₄, LiₓMnO₂, LiₓCoO₂, V₂O₅, V₆O₁₃, V₅S₈, TiS₂, LiₓV₃O₈, V₂S₅, NbSe₃, LiₓNiO₂, LiₓNi_{y}CO_{z}O₂, LiₓNi_{y}Mn_{z}O₂, LiₓCo_{y}Mn_{z}O₂, MoS₂, chromium oxides, molybdenum oxides, niobium oxides, electronically conducting polymers, other forms of organosulfides, and a combination of two or more of the materials of said group.

8. The lithium ion battery of claim 1, wherein said electrolyte is selected from a group consisting of a solvent, a solid polymer, and gel polymer.

9. The lithium ion battery of claim 1, wherein the anode and cathode are separated by an electrolyte absorbed in a microporous separator, or by a free-standing electrolyte.

10. The lithium ion battery of claim 1, wherein said overlying lithium metal electrode in said bonded combination anode is a coating, a plating or a lamination on said carbon electrode.

11. (canceled)

12. (canceled)

13. (canceled)

14. The lithium ion battery of claim 1, wherein each of said anode and said cathode comprises a metallized plastic substrate.

15. The lithium ion battery of claim 14, wherein said metallized plastic substrate comprises an ultra thin metal layer adhered to a polymer selected from the group consisting of polyethylene terephthalate (PET), polypropylene (PP), polyphenylene sulfide (PPS), polyethylene naphthalate (PEN), polyvinylidene fluoride (PVDF), polyethylene (PE), and a combination of two or more polymers thereof.

16. The lithium ion battery of claim 15, wherein said metal layer of the metallized plastic substrate comprises aluminum or copper having a thickness ranging upward from about 0.01 micron, depending on required conductivity, with a resistivity not greater than about 0.1 ohm per square, to enable incorporating a greater number of active components in a battery package of given size, whereby to enhance higher energy density, and to maintain low resistance loss during current drain from the metallized substrate; and said polymer of the substrate comprises a layer ranging in thickness from about 0.5 micron thin to greater than 50 microns.

17. The lithium ion battery of claim 16, wherein said metallized plastic substrate is metallized with a said metal layer on both sides of said polymer layer.

18. The lithium ion battery of claim 17, including an unmetallized margin at opposite edges of the width of the respective anode and cathode, and an active material coating adhered only to the metallized portion of the plastic substrate.

19. The lithium ion battery of claim 1, wherein said electrolyte has relatively low viscosity and relatively high dielectric constant when compared to electrolytes of lithium ion batteries without said anode structure.

20. (canceled)

21. The lithium ion battery of claim 1, having a format of multiple anode and cathode combinations separated by electrolyte.

22. The lithium ion battery of claim 1, including redox shuttle within said electrolyte, to control overcharge of the battery.

23. The lithium ion battery of claim 22, wherein said redox shuttle comprises n-butyl ferrocene.

24. (canceled)

25. A lithium ion battery, comprising an anode, a cathode, and an electrolyte disposed between the two, said battery having an initial charged state in its newly manufactured condition, in which said anode is composed of a lithium-deficient electrode, and a lithium metal layer overlying and adhered to at least a part of the surface of said lithium-deficient electrode of the anode, and said cathode is a separate lithium-deficient electrode adapted to absorb within its lattice structure substantially all lithium ions released by said lithium metal layer of said anode, the quantity of lithium in said lithium metal layer being not greater than will allow it to be fully consumed during the first discharge of the battery from its initial charged state, whereby to substantially eliminate contact between free lithium and said electrolyte while said battery is in its initial charged state.

26. (canceled)

27. The lithium ion battery of claim 25, wherein said first lithium-deficient electrode of the anode is a material selected from a group consisting of carbon, tin oxide, lithium ion-insertion polymers, lithium ion-insertion inorganic electrodes, and carbon insertion electrodes.

28. (canceled)

29. (canceled)

30. The lithium ion battery of claim 25, wherein said cathode is composed of a material selected from the group consisting of oxides, sulfides, selenides, LiₓMn₂O₄, LiₓMnO₂, LiₓCoO₂, V₂O₅, V₆O₁₃, V₅S₈, TiS₂, LiₓV₃O₈, V₂S₅, NbSe₃, LiₓNiO₂, LiₓNi_{y}CO_{z}O₂, LiₓNi_{y}Mn_{z}O₂, LiₓCo_{y}Mn_{z}O₂, MoS₂, chromium oxides, molybdenum oxides, niobium oxides, electronically conducting polymers of polypyrrole, polyaniline, polyacetylene, and polyorganodisulfides, and other forms of organosulfides.

31. The lithium ion battery of claim 25, wherein said electrolyte is a material selected from the group consisting of organic carbonates, liquid solvents, solid polymers and gel polymers.

32. (canceled)

33. (canceled)

34. A method of manufacturing a lithium ion battery, comprising the steps of:
arranging within a housing an anode with a lithium-deficient electrode and a lithium metal member applied in bonded relationship atop a surface of the lithium deficient electrode in confronting relation to a spaced apart lithium deficient cathode, the quantity of lithium in said lithium metal electrode being selected not to exceed the capacity of said cathode to absorb lithium within its lattice structure, interposing an electrolyte between the anode and the cathode in said housing, and completing the manufacture to initially place the battery in its charged state and to suppress contact between free lithium and said electrolyte while in that initial charged state.

35. The method of claim 34, including using carbon as the lithium-deficient electrode of the anode.

36. (canceled)

37. The method of claim 34, including using a cathode composed of a material selected from the group consisting of oxides, sulfides, selenides, LiₓMn₂O₄, LiₓMnO₂, LiₓCoO₂, V₂O₅, V₆O₁₃, V₅S₈, TiS₂, LiₓV₃O₈, V₂S₅, NbSe₃, LiₓNiO₂, LiₓNi_{y}CO_{z}O₂, LiₓNi_{y}Mn_{z}O₂, LiₓCo_{y}Mn_{z}O₂, MoS₂, chromium oxides, molybdenum oxides, niobium oxides, electronically conducting polymers of polypyrrole, polyaniline, polyacetylene, and polyorganodisulfides, other forms of organosulfides, and a combination of two or more of said materials.

38. The method of claim 34, including interposing an electrolyte absorbed in a microporous separator, or a free-standing electrolyte, between the anode and the cathode.

39. (canceled)

40. (canceled)

41. (canceled)

42. The method of claim 35, including selecting the capacity of the lithium metal member of the anode to balance the capacity of the cathode for lithium uptake, and to balance the capacity of the carbon electrode of the anode.

43. The method of claim 34, including using a metallized plastic substrate for at least part of each of said anode and said cathode.

44. The method of claim 43, including selecting said metallized plastic substrate as an ultra thin metal layer adhered to a polymer substrate selected from the group consisting of polyethylene terephthalate (PET), polypropylene (PP), polyphenylene sulfide (PPS), polyethylene naphthalate (PEN), polyvinylidene fluoride (PVDF), polyethylene (PE), and a combination thereof.

45. The method of claim 44, including selecting said metal layer from one of aluminum or copper having a thickness ranging upward from a low of about 0.01 micron, according to required conductivity of the electrode, with a resistivity not greater than about 0.1 ohm per square, to increase the number of active components that may be incorporated in a battery package of given size, whereby to enhance higher energy density, and to maintain low resistance loss during current drain from the metallized substrate; and selecting said polymer substrate as a layer ranging in thickness from about 0.5 microns thin to greater than 50 microns.

46. The method of claim 45, including providing said metallized plastic substrate with a said metal layer adhered to both sides of the polymer layer.

47. The method of claim 46, including leaving an unmetallized margin at opposite edges of the width of the respective anode and cathode, whereby when the metallized plastic substrate is coated with active material, the coating material is coated onto the metallized portion and not the margin.

48. The method of claim 34, including selecting an electrolyte having relatively low viscosity and relatively high dielectric constant when compared to electrolytes of lithium ion batteries without said anode structure.

49. The method of claim 34, including selecting said cathode to be of relatively low voltage, to enhance safety of the battery, when compared to cathodes of lithium ion batteries without said anode structure.

50. The method of claim 34, including producing said battery in a large format of multiple anode and cathode combinations separated by electrolyte.

51. The method of claim 34, including incorporating redox shuttle within said electrolyte, to control overcharge of the battery.

52. The method of claim 51, including using n-butyl ferrocene as said redox shuttle.

53. The method of claim 34, including selecting the material composition of said cathode to produce, in conjunction with the selected materials of said anode and said electrolyte, a desired output curve of battery voltage over time.
